(19) United States
(12) Patent Application Publication
(10) Pub. No.: US 2010/0301716 A1
(43) Pub. Date: Dec. 2, 2010

(54) Storage cabinet peventing removal of objects

(76) Inventor: Richard R. Ranitlla, Bluffton, SC (US)

Correspondence Address: WELSH & FLAXMAN LLC, 2000 DUKE STREET, SUITE 100, ALEXANDRIA, VA, 22314, US

(21) Appl. No.: 12/457,104

(22) Filed: Jun. 1, 2009

(51) Int. Cl. E05B 65/44; G08B 13/14

(52) U.S. Cl. 312/215; 70/78; 340/568.1

(57) ABSTRACT

A storage and dispensing cabinet having a housing with a plurality of compartments and each compartment including a door for controlling access thereto. Each of the compartments including a sensor for identifying whether an object is positioned within the compartment and a lock assembly associated with the doors of the plurality of compartments for controlling access to the compartments for removal of objects stored therein. The lock assembly permits access to one of the selected compartments for removal of the object stored therein only when an object is identified as being positioned within each of the other compartments of the cabinet.

### BACKGROUND OF THE INVENTION

1. Field of the Invention

This invention relates to furniture, specifically storage cabinets typically used by children and teenagers. More particularly, the invention relates to a storage cabinet formed from a plurality of compartments wherein access is restricted to the storage compartments until objects, such as toys, removed from one of said plurality of storage compartments are replaced.

2. Description of the Related Art

Storage furniture (shelving, cabinets, chests, chests of drawers, closets, etc.), both in the home and the workplace, is used for several purposes, such as protecting the items stored in them, for assigning a specific place for the items so they can be easily found, for aesthetic display of the contents and to encourage removed objects to be returned to their storage place when not in use. With these purposes in mind, storage furniture has evolved to include with multiple storage compartments, with doors to protect the contents and with locks and latches to prevent unauthorized or accidental access.

In the case of storage cabinets for small children, the children using them do not typically understand the above objectives and need to be supervised and/or taught these objectives. In particular, children need to learn to replace their toys in their storage places after the toys have been used. Common children's storage chests and cabinets allow the child to remove as many toys as desired or even all the toys from the storage device. A problem arises when the child is expected to put away all the toys, for example, before dinner or before going to bed. The child, not realizing during play time how many toys were removed, is overwhelmed by the task of putting so many toys away, or is simply not cooperative in this particular goal.

File cabinets with drawer interlocks, for example U.S. Pat. No. 1,006,983 to Schaffert allow only one drawer at a time to be open, but have no limit on adding or removing contents from the open drawer, so a variation of that mechanism would not prevent the child from eventually spreading all the toys all over the room.

More complicated supply stations with internal computers, for example U.S. Pat. No. 5,520,450 by Colson, Jr. et al., while being very complicated and expensive for a child toy storage application, do not sense the absence or removal of contents and thus could not prevent the child operator from removing all the items contained in all the compartments.

A controlled inventory storage device, for example the U.S. Patent Application Publication No. 2006/0276933 by Chavez et al., while also being very complicated and expensive for a child toy storage application, could sense the absence of toys in a given compartment, but the control logic in the device of Chavez is designed to only use this information to warn the owner of low inventory, not to prevent access to other compartments.

As such, a need exists for a storage cabinet restricting access to storage compartments until objects removed from another storage compartment are replaced. The present invention provides such a storage cabinet.

### SUMMARY OF THE INVENTION

It is, therefore, an object of the present invention to provide a storage and dispensing cabinet having a housing with a plurality of compartments and each compartment including a door for controlling access thereto. Each of the compartments including a sensor for identifying whether an object is positioned within the compartment and a lock assembly associated with the doors of the plurality of compartment for controlling access to the compartments for removal of objects stored therein. The lock assembly permits access to one of the selected compartments for removal of the object stored therein only when an object is identified as being positioned within each of the other compartments of the cabinet.

Another object is to provide a storage and dispensing cabinet wherein the lock assembly permits access to one of the selected compartments for removal of the object stored therein only when all of the compartment doors are closed.

Yet another object of the invention is wherein the rotatable disc interacts with knobs secured to the respective doors allowing or preventing the rotatable disc from freely rotating and the rotatable disc includes a magnetic screw mounted thereon and the housing of the cabinet includes magnets mounted at selected positions thereon such that the magnetic screw and magnets interact when the rotatable disc is rotated.

It is another object to provide a storage and dispensing cabinet wherein the sensor is a weight sensor, in particular a spring secured to a movable floor of the compartment and the spring is biased such that when an object is positioned upon the floor, the spring moves downwardly under the weight of the object thereby providing the floor with an unoccupied orientation and an occupied orientation.

Still another object is to provide a storage and dispensing cabinet such that the door is prevented from closing when the floor is in the unoccupied orientation.

Yet another object is to provide a storage and dispensing cabinet wherein the objects positioned within each compartment are specific objects that can be sensed by the device and the lock assembly allows access only when all the specific objects are in their respective compartments.

In another embodiment of the invention it is an object to provide a storage and dispensing cabinet wherein the lock assembly is composed of a camshaft upon which is mounted a plurality of cam lobes and each cam lobe is associated with each of the respective compartments and each of the cam lobes is a substantially cylindrical member with a missing an arcuate segment.

In yet another embodiment of the invention it is an object to provide a storage and dispensing cabinet wherein the lock assembly includes a plurality of solenoid lock members associated with the plurality of storage compartments and the sensor is an infrared type sensor.

Another object of the invention is wherein the infrared sensor includes a sensor emitter and infrared sensor which are linked to an electronic lock controller controlling the lock assembly.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a front plan view of the present storage and dispensing cabinet in accordance with a first embodiment.

FIG. 2A is a cross-sectional view showing one of the cabinets with the door in its fully closed orientation.

FIG. 2B is a detailed cross-sectional showing an upper compartment having the door oriented when the compartment is unoccupied and a lower compartment having the door oriented when the compartment is occupied.

FIG. 3A is a top cross-sectional view of a compartment with its door in its fully closed orientation.

FIG. 3B is a top plan view of a door oriented when the compartment is unoccupied and being blocked by the floor.

FIG. 4 is a front perspective view of the storage and dispensing cabinet shown with reference to FIG. 1.

FIG. 5 is a detailed perspective view of the storage and dispensing cabinet showing a compartment in its occupied orientation.

FIG. 6 is a detailed perspective view of a compartment in its occupied orientation with the lock assembly aligned for opening of the door.

FIG. 7 is a perspective view of a compartment in its unoccupied state with the door open and the floor raised.

FIG. 8 is a perspective view of a compartment with the door in a closed, but not fully closed orientation.

FIG. 9 is a perspective view showing locking of the lock assembly by a knob.

FIG. 10 is a rear perspective view of the storage and dispensing cabinet.

FIG. 11 is an unassembled view of the storage and dispensing cabinet.

FIG. 12 is a front plan view of a storage and dispensing cabinet in accordance with a second embodiment.

FIG. 13 is a detailed perspective view showing operation of the lock assembly.

FIG. 14 is a detailed perspective view showing spring actuation of the floor.

FIG. 15 is a detailed perspective view showing operation of the lock assembly.

FIG. 16 is a perspective view showing the storage and dispensing cabinet.

FIG. 17 is a detailed perspective view showing a compartment with the door in its fully closed orientation.

FIG. 18 is a detailed perspective view showing the door open and the compartment still occupied.

FIG. 19 is a detailed perspective view showing the door open and the compartment unoccupied.

FIG. 20 is a detailed perspective view showing the door closed, but not fully closed with the floor interfering with full closure of the door.

FIG. 21 shows an attempt to open an adjacent compartment when another compartment is unoccupied.

FIG. 22 is a detailed perspective view showing occupied compartments while

FIG. 23 shows how an adjacent compartment may be open once the first compartment is occupied.

FIGS. 24 and 25 are detailed views showing the lock assembly in accordance with this embodiment.

FIG. 26 is a front plan view of a storage and dispensing cabinet in accordance with a third embodiment.

FIG. 27 is a top plane view of the storage and dispensing cabinet shown in FIG. 26.

FIG. 28 is an exploded top view of a storage and dispensing cabinet in accordance with the third embodiment.

FIG. 29 is an exploded front view of a storage and dispensing cabinet in accordance with a third embodiment.

### DESCRIPTION OF THE PREFERRED EMBODIMENTS

The detailed embodiment of the present invention is disclosed herein. It should be understood, however, that the disclosed embodiments are merely exemplary of the invention, which may be embodied in various forms. Therefore, the details disclosed herein are not to be interpreted as limiting, but merely as a basis for teaching one skilled in the art how to make and/or use the invention.

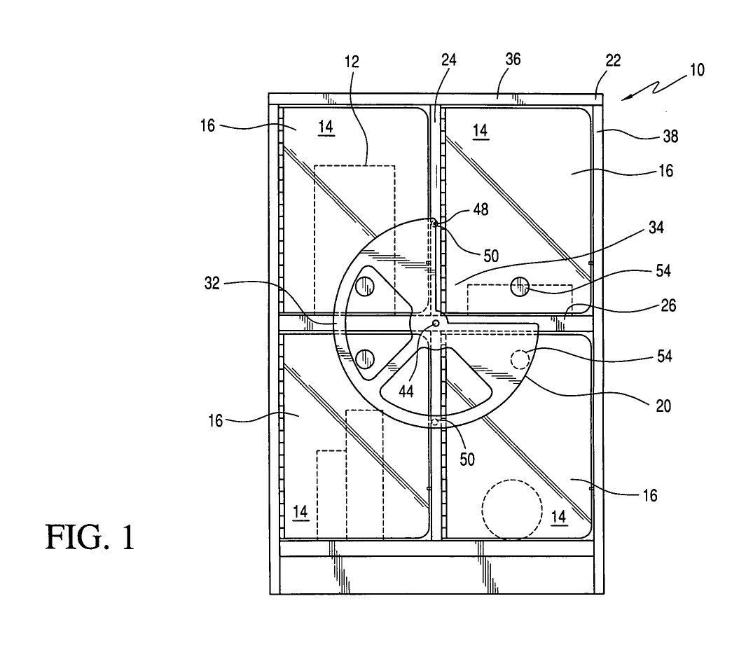

In accordance with the present invention, and with reference to FIGS. 1 to 11, storage and dispensing cabinet 10 is disclosed. The storage and dispensing cabinet 10 provides an economically feasible system for the storage, display and controlled access of objects 12, requiring only the operating skills typical of small children. In accordance with the present invention, it is contemplated objects 12 may take many forms, such as, toys, books, games, stuffed animals, etc. The present storage and dispensing cabinet 10 allows the user, in particular, a child, to have only one, or a limited number, of objects 12 out of the storage and dispensing cabinet 10 at any given time. Not only does use of the present storage and dispensing cabinet 10 in a home or school with young children limit the clutter of objects 12 scattered all over, but it educates the child in keeping the play area orderly without requiring parental intervention.

Referring now to the various embodiments disclosed herein, the present storage and dispensing cabinet 10 includes a plurality of compartments 14. Each compartment 14 includes a door 16 controlling access thereto. A sensor 18 is associated with each of the compartments 14 for identifying whether a predetermined object 12, for example, a toy, is positioned within respective compartments 14 and a lock assembly 20 is associated with respective doors 16 and sensors 18 of the plurality of compartments 14 for controlling access to the compartment 14 for removal of an object stored therein.

In practice, the lock assembly 20 permits access to selected compartments 14 of the storage and dispensing cabinet 10 only when the sensor 18 identifies all of the objects 12 as being positioned within respective compartments 14 of the storage and dispensing cabinet 10.

Referring now to FIGS. 1 to 11, a preferred embodiment of the present storage and dispensing cabinet 10 is disclosed. In accordance with this embodiment, the plurality of compartments 14 are formed within a housing 22. The compartments 14 may be vertically oriented or horizontally oriented. In accordance with this embodiment, the storage and dispensing cabinet 10 includes four compartments 14. Each of the compartments 14 is in the shape of a square and the entire storage and dispensing cabinet 10 is in the shape of a square as the compartments 14 are arranged in a two-row and two-column formation.

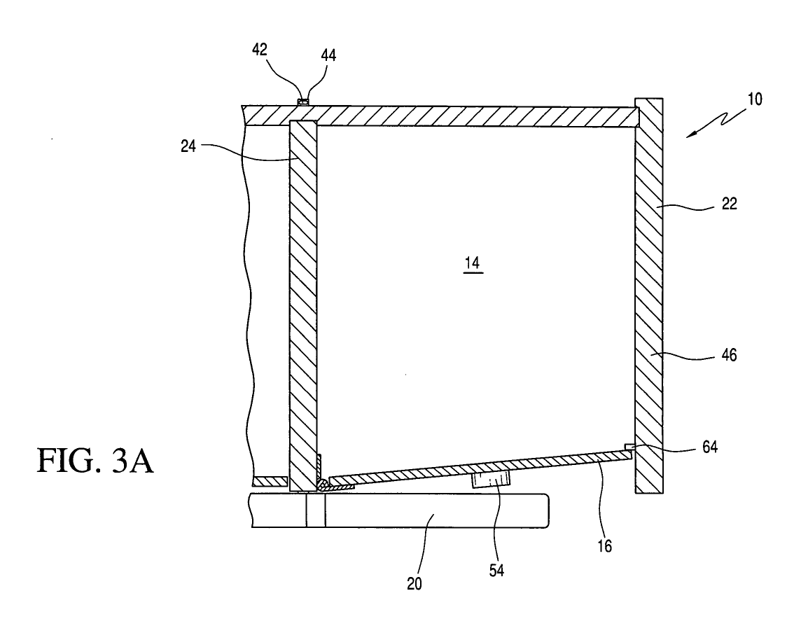

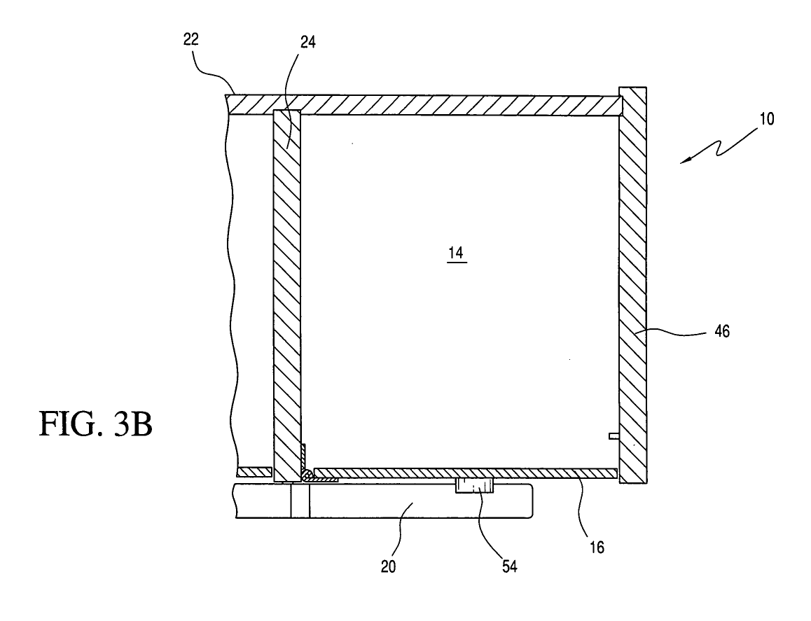

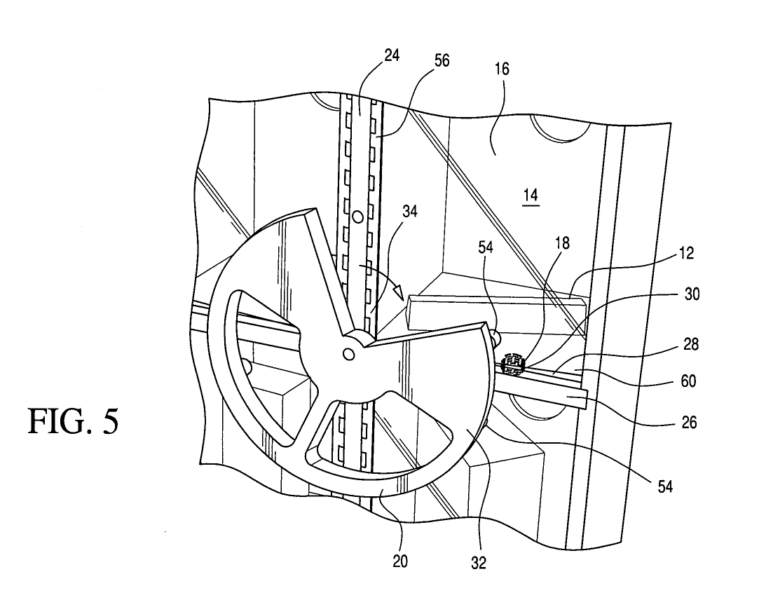

Each of the compartments 14 includes a hinged door 16 (see FIGS. 3A, 3B and 5). The door 16 is hinged to a first lateral sidewall 24 of the compartment 14 allowing one to pivot the door 16 outward for ready access to the contents held therein. However, and as will be discussed below in greater detail, rotation of the door 16 for access to a selected compartment 14 is only permitted when the lock assembly 20 is properly positioned.

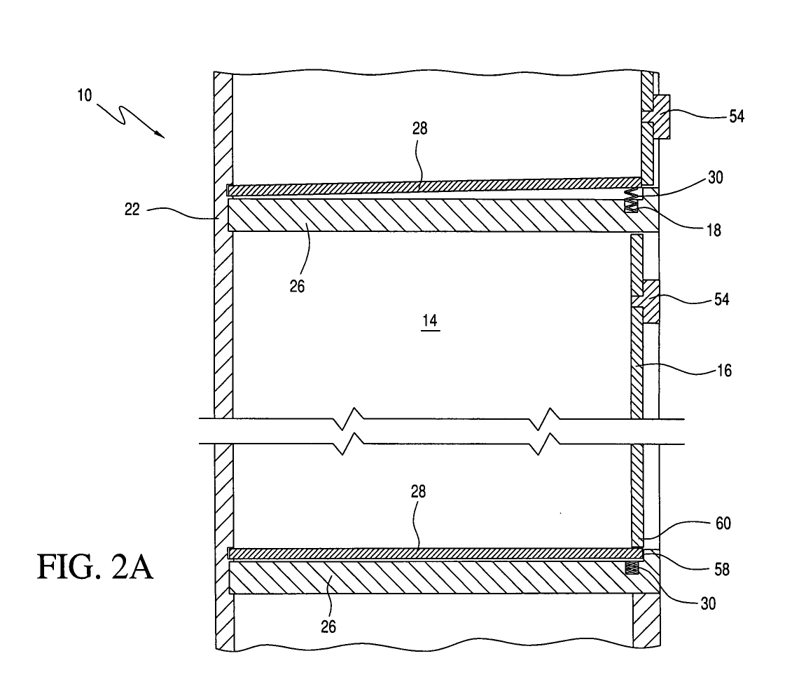

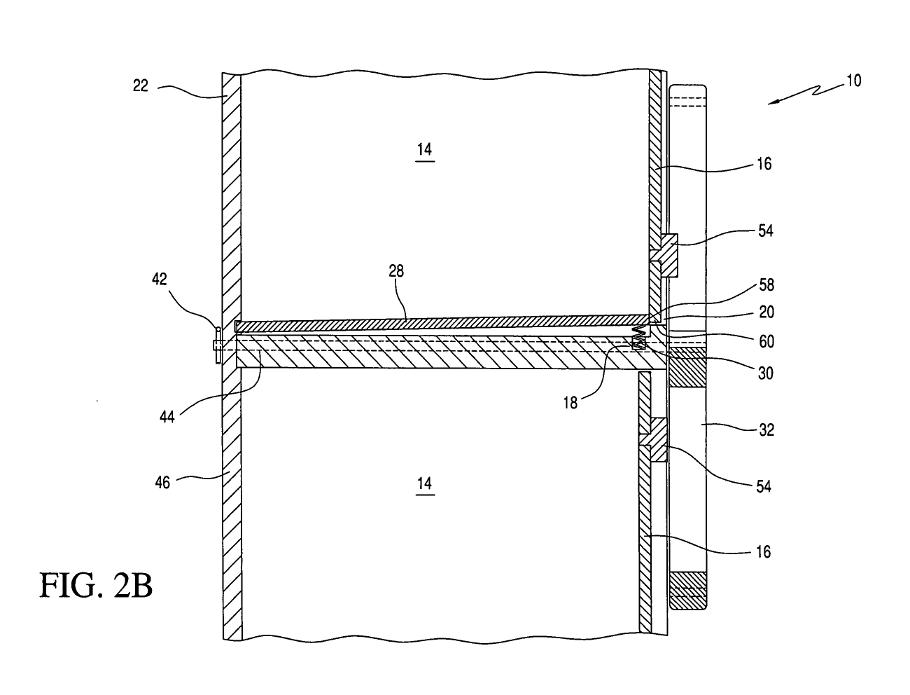

In addition, each compartment 14 includes a sensor 18 (see FIGS. 2A, 2B, and 5) associated with the floor 28 of each compartment, wherein the sensor 18 and floor 28 sit upon the base 26 of the compartment 14. In accordance with a preferred embodiment, the sensor 18 is a spring 30 secured to the movable floor 28, and interposed between the floor 28 and the base 26. The spring 30 is biased such that when an object 12 is positioned thereon, the spring 30 moves downwardly under the weight of the floor (see FIGS. 2A, 5 and 6). More particularly, when the compartment 14 is unoccupied (compare FIGS. 2A, 3A and 6 (occupied) with FIGS. 2B, 3B and 7 (unoccupied), the spring 30 raises the floor 28, that is, moves it upwardly away from the base 26, thereby preventing the door 16 from closing (see also FIGS. 2B, 3B 7 and 8) to the fully closed position (as in FIGS. 2A, 3A, 4, 5 and 6) and ultimately preventing access thereto.

It is contemplated in accordance with the present invention that the spring needs to be only strong enough to lift the empty floor. Any “significant” weight will lower the floor. In practice, it is contemplated a test weight of 2 ounces placed in the center of the floor, 2 inches back from the door will be used to test the responsiveness of the floor.

While a particular weight sensor is employed in accordance with a preferred embodiment of the present invention, other sensors are contemplated for use in identifying whether the objects are stored in appropriate compartments. Such sensors may take a variety of forms known to those skilled in the art.

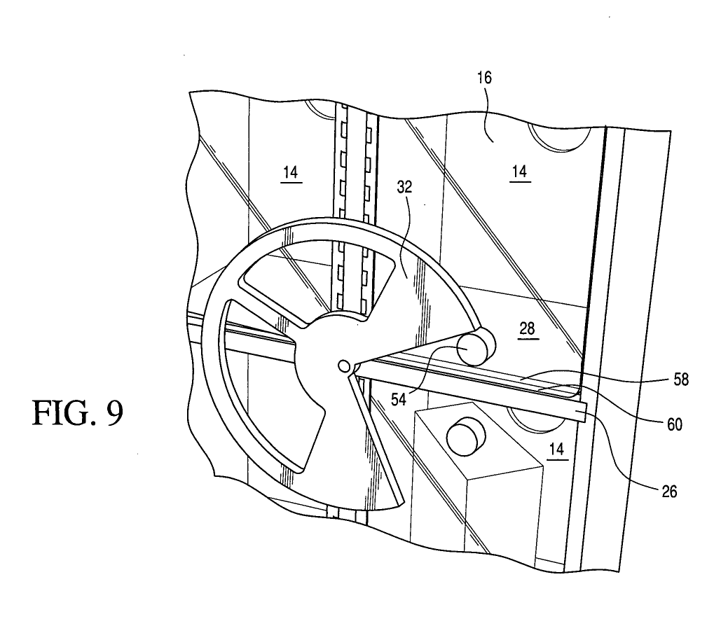

With regard to the lock assembly 20, the lock assembly 20 in accordance with this embodiment is composed of a rotatable disc 32 missing a 90-degree arcuate segment 34. In accordance with a preferred embodiment of the present invention, the rotatable disc 32 interacts with outwardly extending knobs 54 of the respective doors 16, allowing (FIGS. 2A, 3A and 5) or preventing (FIGS. 2B, 3B and 9) the rotatable disc 32 from freely rotating. As a result of the shape of the rotatable disc 32, the rotatable disc 32 prevents operation of at least three doors 16 when the arcuate segment 34 is aligned with a fourth door 16, and ultimately prevents access to the contents of the compartments 14 associated with the three locked doors 16 until such a time that an object 12 is replaced into the one open compartment 14 (compare FIG. 9 to FIG. 5).

With regard to the details of the respective compartments 14, they are substantially identical and the first compartment 14 will be disclosed herein as those of ordinary skill in the art will understand that each of the compartments 14 includes a substantially similar construction with adjacent compartments sharing adjacent walls. Each compartment 14 includes a base 26 and top wall 36 with first and second lateral sidewalls 24, 38 connecting the base 26 to the top wall 36. The door 16 is pivotally secured to the first lateral sidewall 24.

As shown with reference to FIG. 9, when any of respective doors 16 are not in their fully closed position (that is, when rotated inwardly such that the lower edge 60 of the door 16 rests against the raised floor front edge 58 as shown with reference to FIG. 2A), their knob 54 interferes with the rotatable disc 32 preventing the rotatable disc 32 from moving to a position that allows access to the other compartments 14. The doors 16 are prevented from moving to their fully closed position by the floor 28 when the object 12 is not positioned upon the floor 28.

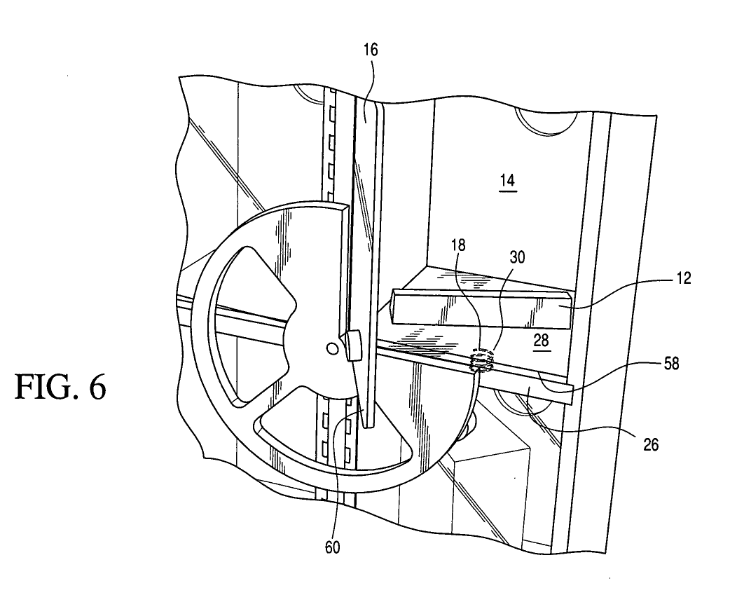

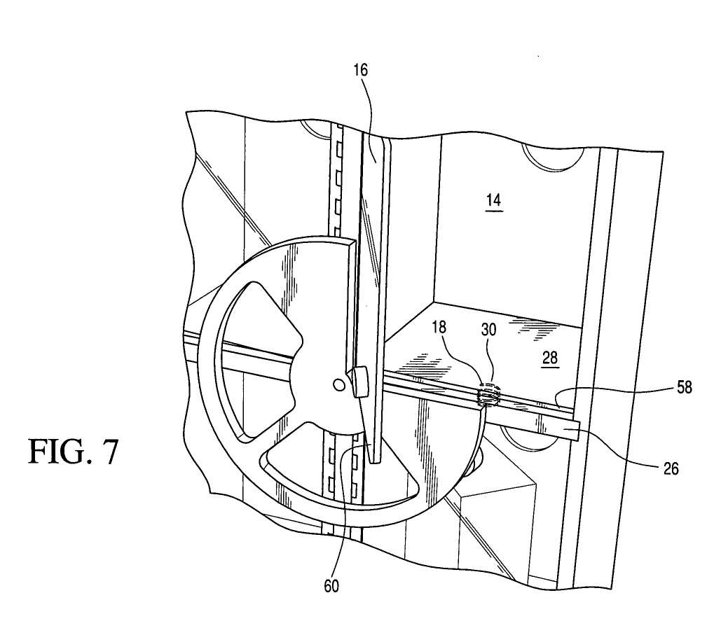

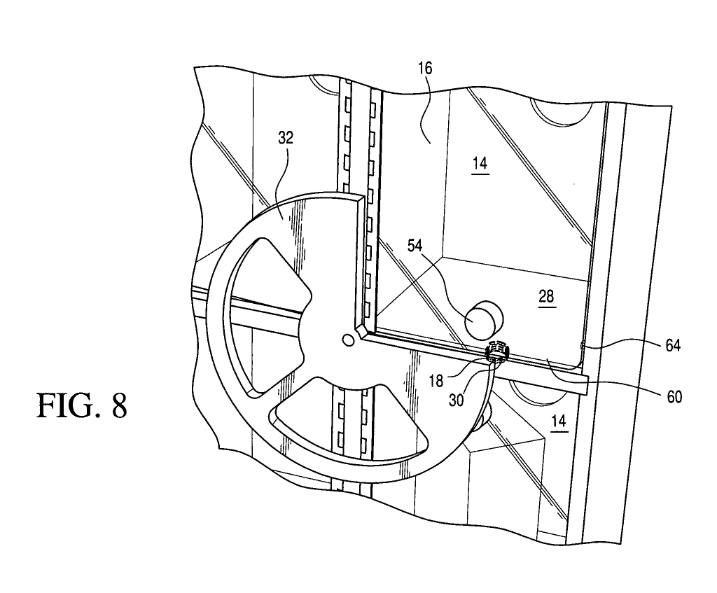

In particularly, and as briefly discussed above, the floor 28 is upwardly biased by a spring interposed between the base 26 and the floor 28. As a result, when the toy is positioned upon the floor 28, the floor 28 moves downwardly against the bias of the spring 30 to a first position (see FIG. 6). When the object 12 is removed, the floor 28 moves upwardly under the spring force of the spring 30 to a second position (see FIG. 7). When in its first position, the front edge 58 of the floor 28 is pushed downwardly adjacent the base 26 and the door 16, in particular, the lower edge 60 of the door 16 is free to move over the floor 28 as the door 16 rotates inwardly to its fully closed position with the knob 54 recessed sufficiently to allow for rotation of the rotatable disc 32 (see FIG. 5). When the object 12 is removed and the floor 28 is allowed to move to its second position (see FIG. 7), the front edge 58 of the floor 28 is pushed upwardly away from the base 26 and the door 16, in particular, the lower edge 60 of the door 16 is aligned for abutment with the floor 28 as the door 16 (see FIG. 8) rotates inwardly preventing the door 16 from moving to its fully closed position (as in FIG. 5). As a result, the knob 54 extends outwardly sufficiently to interact with the rotatable disc 32 and prevent rotation thereof (see FIG. 9).

The only way for the child to access (and remove an object 12 from) another compartment 14 is to return an object 12 to the open compartment 14. Once the object 12 is returned to the compartment 14, the floor 28 of the compartment 14 is lowered under the control of the spring 30. This then allows rotation of the rotatable disc 32 that ultimately allows for access to other compartments 14. Further, the lock assembly 20 permits access to one of the selected compartments 14 for removal of the object 12 stored therein only when all of the compartment doors 16 are closed.

Once an object 12 is placed on the floor 28 and the floor 28 moves downwardly, the door 16 can be completely closed, and potential rotation of the rotatable disc 32 is achieved.

It should be appreciated that the frame of the storage and dispensing cabinet 10 is made from inexpensive and durable, non-toxic material such as wood that is suitable for children's furniture and easily cleaned by parents. However, those skilled in the art will appreciate that other materials, such as plastics and metals, may be utilized without departing from the spirit of the present invention.

In accordance with a preferred embodiment, the door 16 is made from a transparent but durable material. This allows the child to see the contents of the compartment 14. Although a transparent door is disclosed in accordance with a preferred embodiment, it is contemplated other door structures may be utilized without departing from the spirit of the present invention. In the event an opaque door is used, mirrors, labels, photographs, displays, video cameras or other similar structures may be utilized to provide the child with a visual indication as to the contents of the compartment.

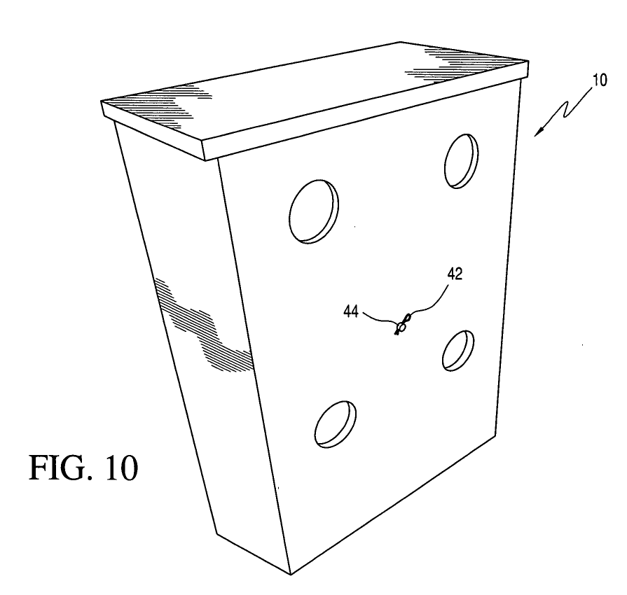

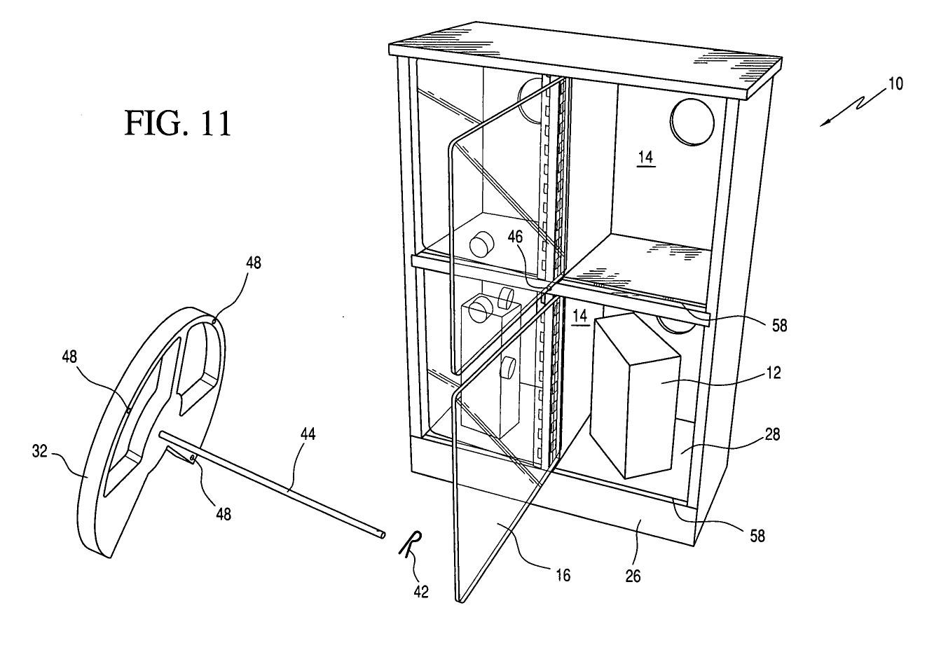

Operation of the storage and dispensing cabinet 10 begins when the parent or supervisor removes the pin 42 from the shaft 44 of the rotatable disc 32 (see FIG. 10) and then removes the shaft 44 and rotatable disc 32 (see FIG. 11) from the frame 46 of the storage and dispensing cabinet 10. This allows full access to all of the compartments 14, which can then be filled with objects 12. The parent should insure that each object 12 has sufficient weight to lower the floor 28, in particular the front edge 58 of the floor 28 to a position equal or below the base 26. The rotatable disc 32 and shaft 44 are then replaced in the hole in frame 46 and the securing pin 42 is also replaced before the storage and dispensing cabinet 10 is presented to the child for use.

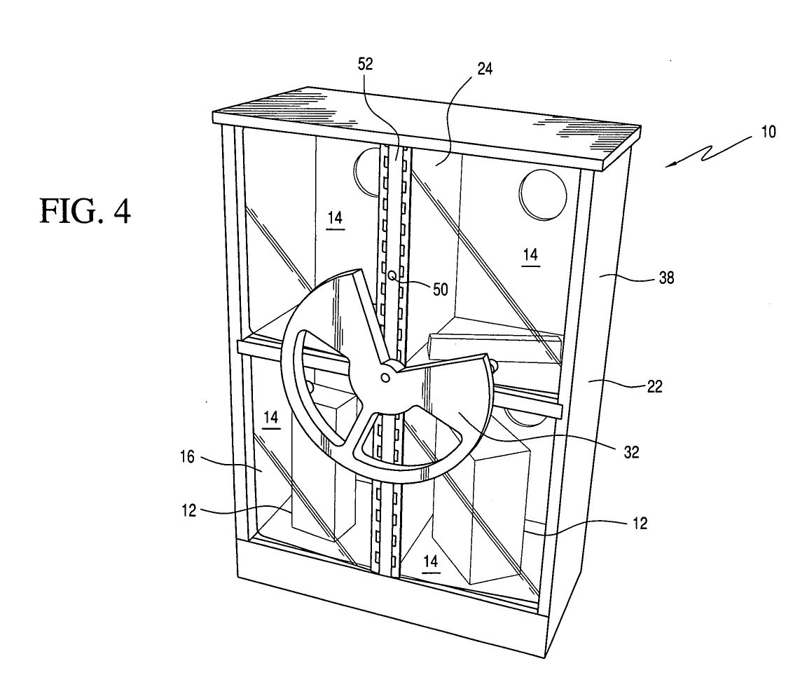

The rotatable disc 32 can rest in any position with the missing arcuate segment 34 exposing the door 16 or between doors. A magnetic (for example, iron) screw 48 (FIG. 11) mounted on the rotatable disc 32 and magnets 50 (FIGS. 4 & 11) mounted at selected positions on the central wall 52 of the frame 46 help keep the rotatable disc 32 lined up with specific doors 16 based upon usage of the present storage and dispensing cabinet 10.

The child operates the storage and dispensing cabinet 10 by observing the objects 12 in the compartments 14 through the transparent door 16 until the child decides which object 12 to select and play with. The child then rotates the rotatable disc 32 to an appropriate position, grasps the knob 54 on the door 16 to the selected compartment 14 and opens the door 16. The child then removes the desired object 12, relieving that object's weight from the spring-biased floor 28. The floor 28 then rises under the influence of the spring 30 and the spring loaded hinge 56 securing the door to the first lateral sidewall 24 will close the door 16 although the door 16 is not fully closed because the floor 28 will interfere with complete closing of the door 16. In addition, the knob 54 of the not fully closed door 16 will partially fill the missing arcuate segment 34 of the rotatable disc 32 thereby preventing the rotatable disc 32 from further rotation and preventing access to the other compartments 14 via the doors 16.

Once the child tires of the first object 12 and tries to rotate the rotatable disc 32 to select another object 12, the child will be unable to do so. At first the parent or supervisor will explain to the child that they must return the first object 12 to the storage and dispensing cabinet 10 before they can select another object 12. Upon returning the object 12 to the first compartment 14, the floor 28 will lower against the bias of the spring 30. This will allow the door 16 to fully close and permit the rotatable disc 32 to rotate to a position permitting access to another compartment 14 and ultimately another object. Children will very quickly learn to do this on their own.

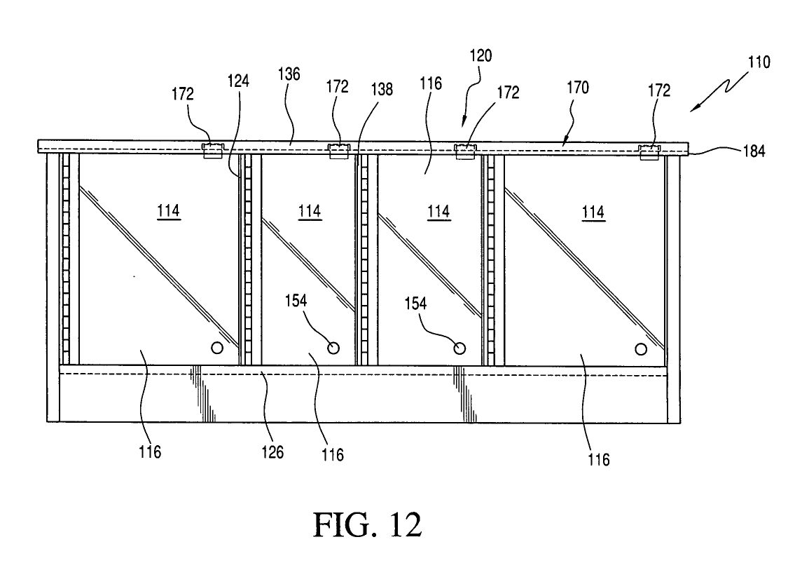

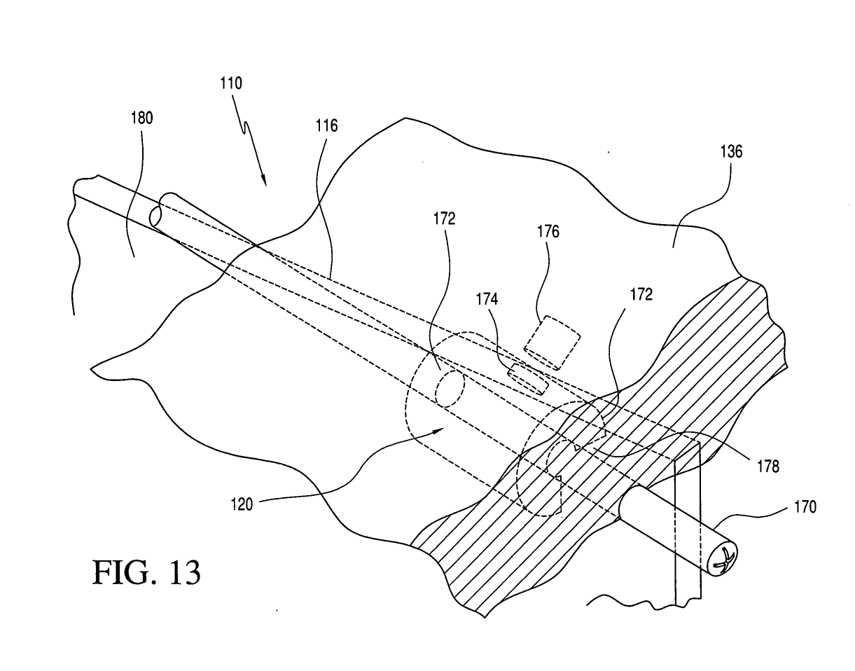

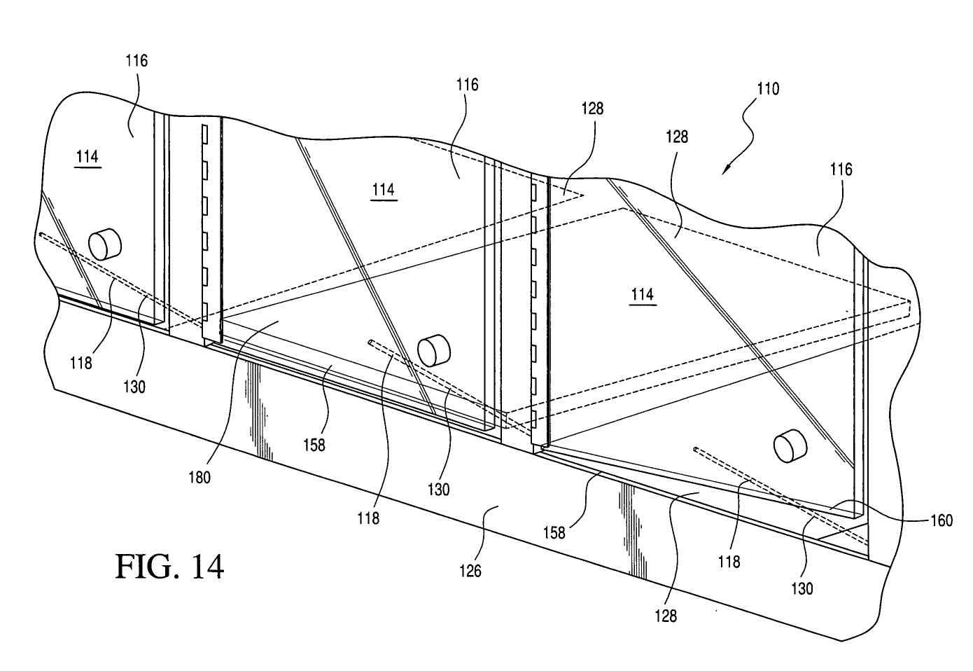

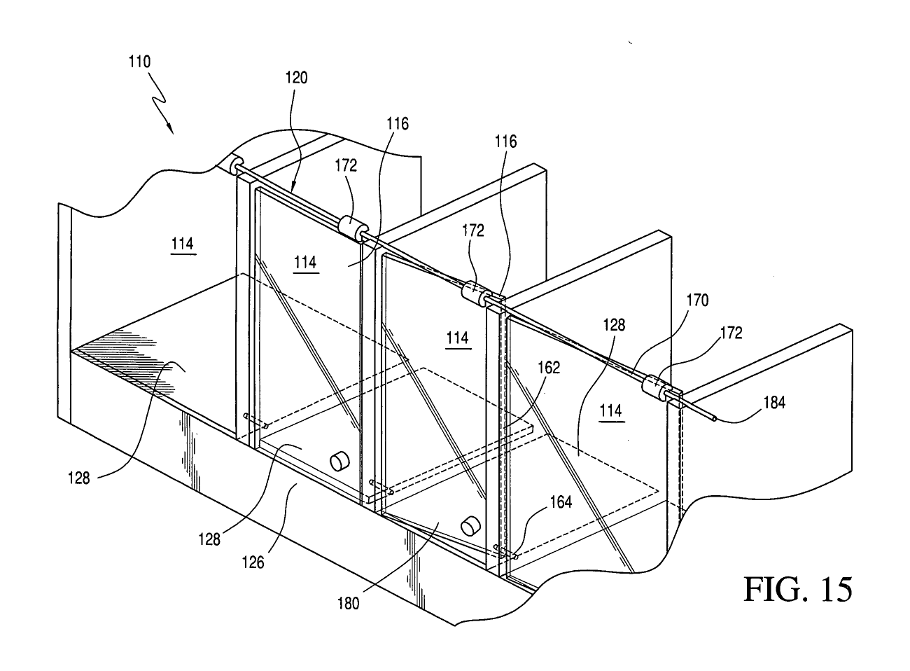

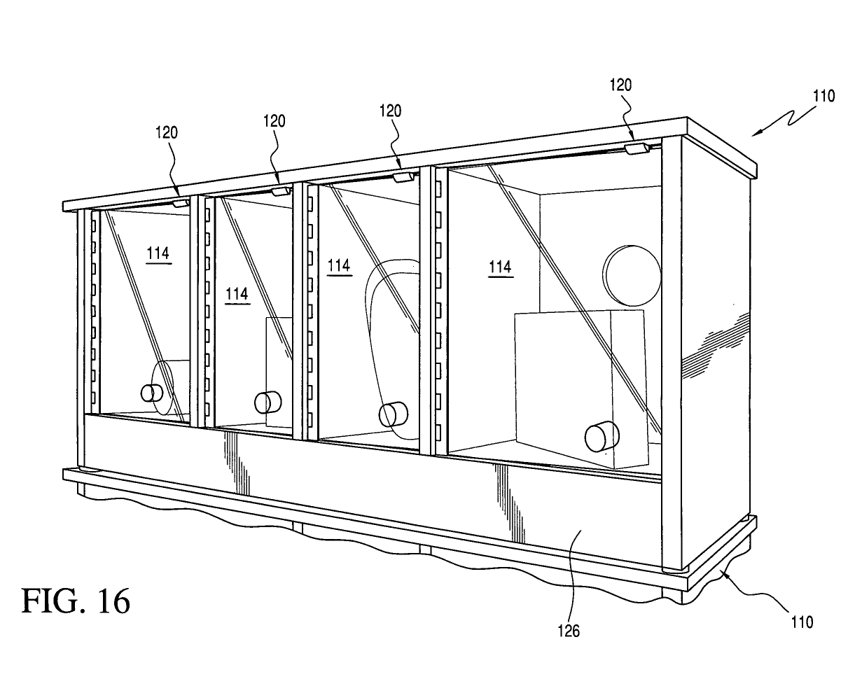

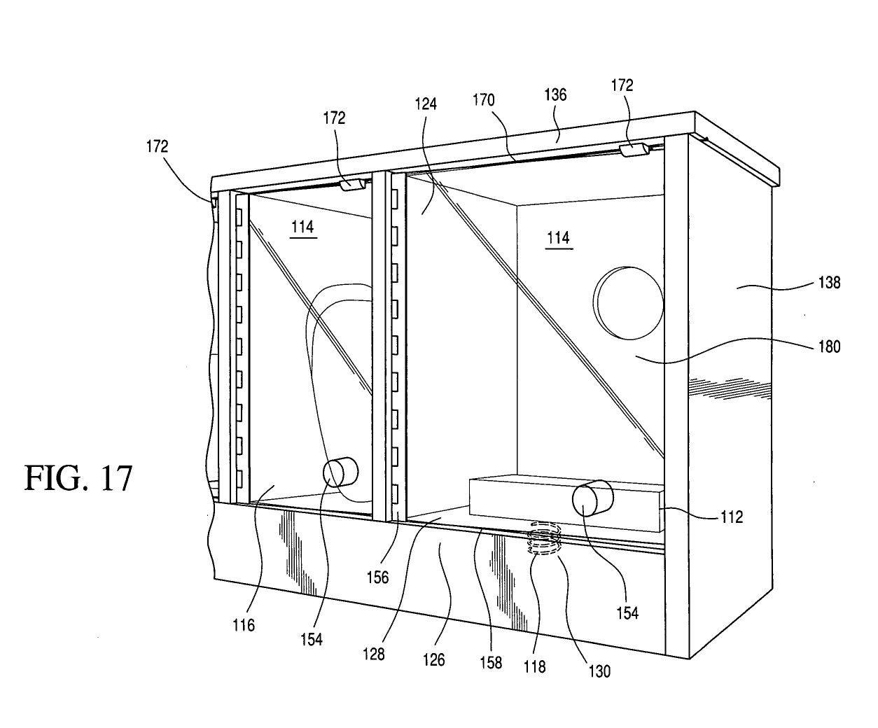

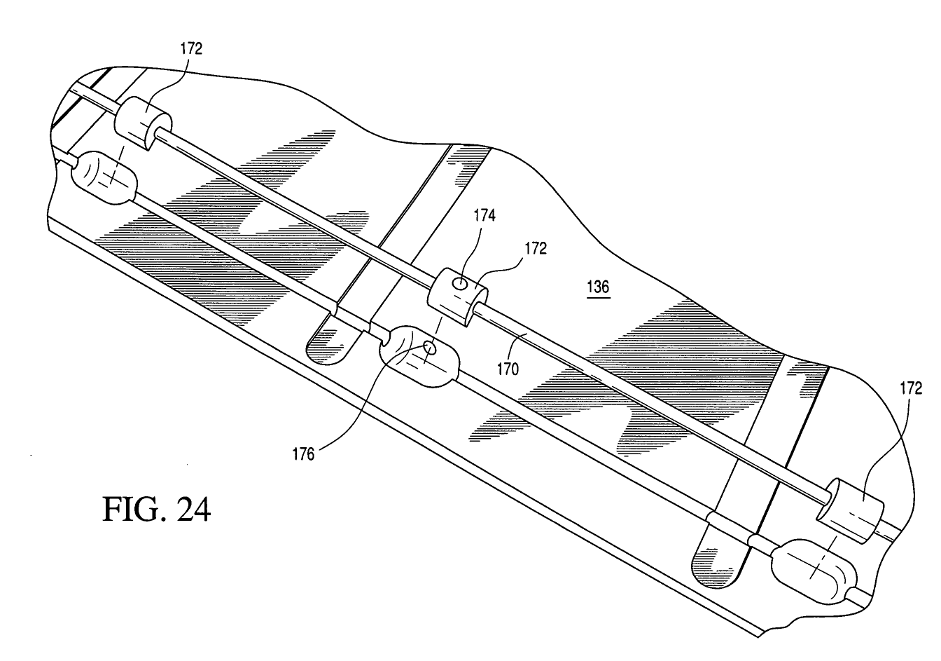

In accordance with an alternate embodiment as shown with reference to FIGS. 12 to 25, the storage and dispensing cabinet 110 includes a plurality of horizontally oriented compartment 114. As with the prior embodiment, opening and closing of the respective compartment is controlled by a lock assembly 120.

With regard to the details of the respective compartments 114, they are substantially identical and the first compartment 114 will be disclosed herein as those of ordinary skill in the art will understand that each of the compartments 114 includes a substantially similar construction with adjacent compartments sharing adjacent walls. Each compartment 114 includes a base 126 and top wall 136 with first and second lateral sidewalls 124, 138 connecting the base 126 to the top wall 136. The door 116 is pivotally secured to the first lateral sidewall 124.

Each of the compartments 114 includes a spring-loaded hinge 156 rotatably connecting the door 116 to a first lateral sidewall 124 of the compartment 114 allowing one to rotate the door 116 outward for ready access to the objects 112 held therein. While a rotatable door is disclosed in accordance with a preferred embodiment of the present invention, other door structures, for example, sliding doors, are contemplated for use in accordance with the present invention. As with the prior embodiment, each door 116 is also provided with a knob 154 permitting the child to select and open, or attempt to open, the door 116.

In accordance with an alternative embodiment, and as with the prior embodiment, the door 116 is made from a transparent, but durable material. This allows the child to see the contents of the compartment 114. Although a transparent door is disclosed in accordance with a preferred embodiment, it is contemplated other door structures may be utilized without departing from the spirit of the present invention. If an opaque door were to be used, mirrors, labels, photographs, displays, video cameras or other similar structures may be utilized to provide the child with a visual indication as to the contents of the compartment.

In addition, each compartment 114 includes a sensor 118 associated with the floor 128 of each compartment, wherein the sensor 118 and floor 128 sit upon the base 126 of the compartment 114. In accordance with a preferred embodiment, the sensor 118 is a spring 130 secured to the movable floor 128, which senses weight, and interposed between the floor 128 and the base 126 adjacent the forward edge 158 of the floor 128. The spring 130 is biased such that when an object 112 is positioned thereon, the spring 130 moves downwardly. More particularly, when the compartment 114 is unoccupied, the spring 130 raises the floor 128, that is, moves it upwardly away from the base 126, thereby preventing the door 116 from closing to the fully closed position and ultimately preventing access to other compartments (see FIG. 12). As discussed above with regard to the other embodiment, it is further contemplated other sensor types may be employed, for example, an optical sensor which senses the presence of an object in one or more of the compartments and cooperates with a lock assembly to prevent opening of all doors but the one in which an object has been removed may be employed.

With regard to the lock assembly 120, the lock assembly 120 in accordance with this embodiment is composed of a camshaft 170 upon which is mounted a plurality of cam lobes 172, each of the cam lobes 172 being associated with a respective compartment 114 for interaction with the doors 116 to selectively allow or prevent opening of the doors 116. The cam lobes 172 are fixedly secured to the camshaft 170 and rotate with the camshaft 170 when acted upon by the doors 116 as discussed herein. First and second magnets 174, 176 are respectively mounted on the cam lobes 172 and the top wall 136 of the housing 122 to control movement of the camshaft 170 and cam lobes 172 as contemplated in accordance with the present invention.

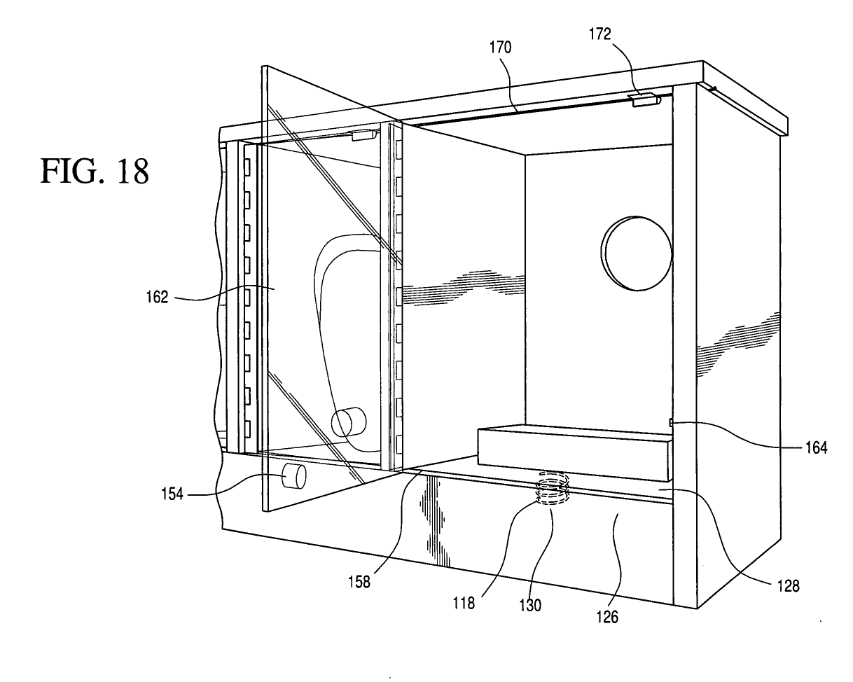

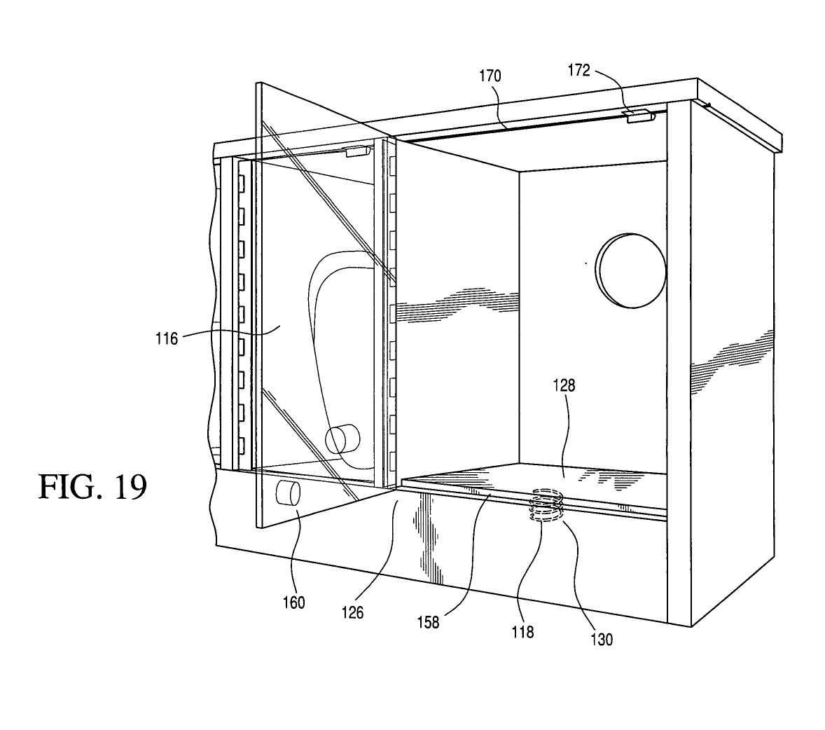

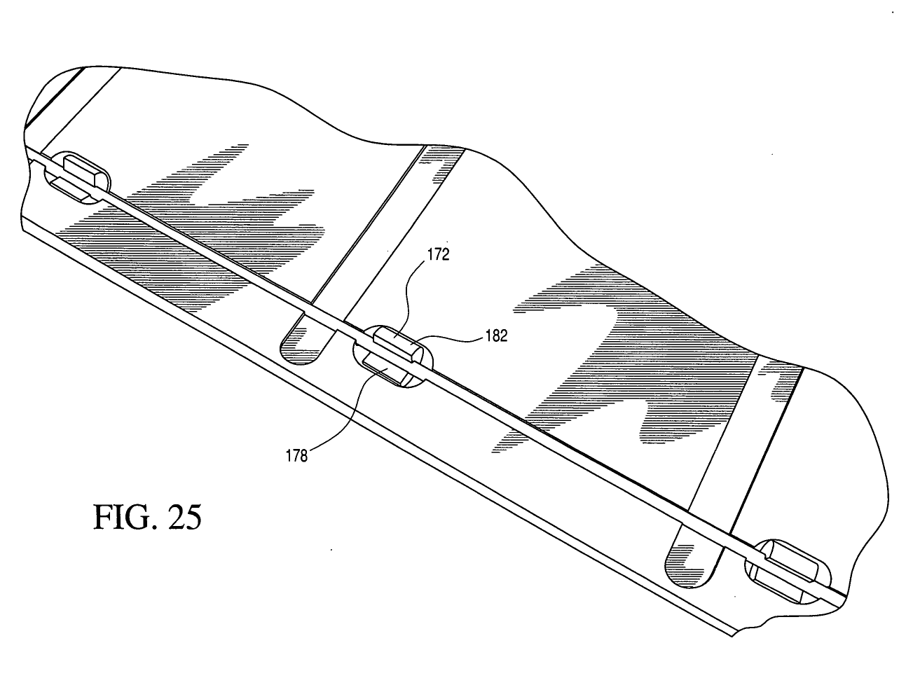

Each of the cam lobes 172 is a substantially cylindrical member with a 90-degree arcuate segment 178 (i.e., pie piece) cut out of it. As a result, when all the doors 116 are fully closed (and all of the objects 112 are in position within the respective compartments 114) and the cam lobe 172 is oriented with the arcuate segment 178 facing the front surface 180 of the respective doors 116, one may open one door 116 and retrieve a object 112. This causes the rotation of the camshaft 170 and the cam lobes 172 mounted thereon (see FIG. 18). Upon withdrawal of the object 112 (see FIG. 19), the sensor 118 lifts the floor 128 and prevents rotation of the open door 116 to its fully closed position thereby locking the camshaft 170 in it rotated position. Now the rounded surfaces 182 (see also FIG. 25) of the cam lobes 172 face all of the closed doors 116 preventing opening thereof until the object 112 is replaced and the door 116 is fully closed (that is, when rotated inwardly such that the outer edge 162 (see FIG. 18) of the door 116 rests against the door stop 164) in a manner rotating the cam lobes 172 back to their original position.

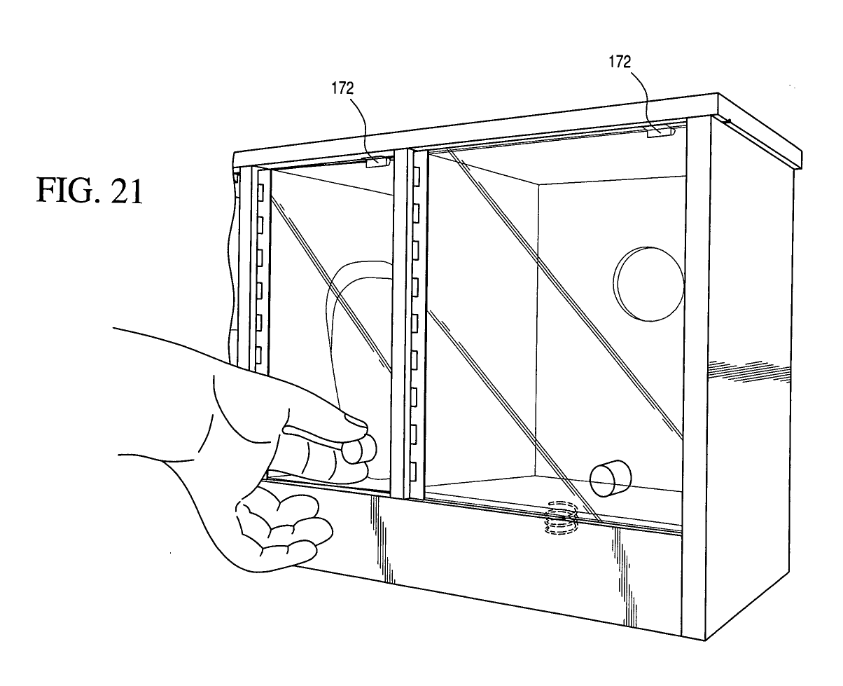

In particularly, and as discussed above, the floor 128 is upwardly biased by a spring interposed between the base 126 and the floor 128. As a result, when the object 112 is positioned upon the floor 128, the floor 128 moves downwardly against the bias of the spring 130 to a first position. When the object 112 is removed, the floor 128 moves upwardly under the spring force of the spring 130 to a second position. When in its first position, the forward edge 158 of the floor 128 is pushed downwardly adjacent the base 126 and the door 116, in particular, the lower edge 160 of the door 116 is free to move over the floor 128 as the door 116 rotates inwardly to its fully closed position (compare FIGS. 18 and 19). When the object 112 is removed and the floor 128 is allowed to move to its second position, the forward edge 158 of the floor 128 is pushed upwardly away from the base 126 and the door 116, in particular, the lower edge 160 of the door 116 is aligned for abutment with the floor 128 as the door 116 rotates inwardly preventing the door 116 from moving to its fully closed position. While the door 116 is in this semi-closed position (see FIG. 21) none of the other doors 116 can be opened.

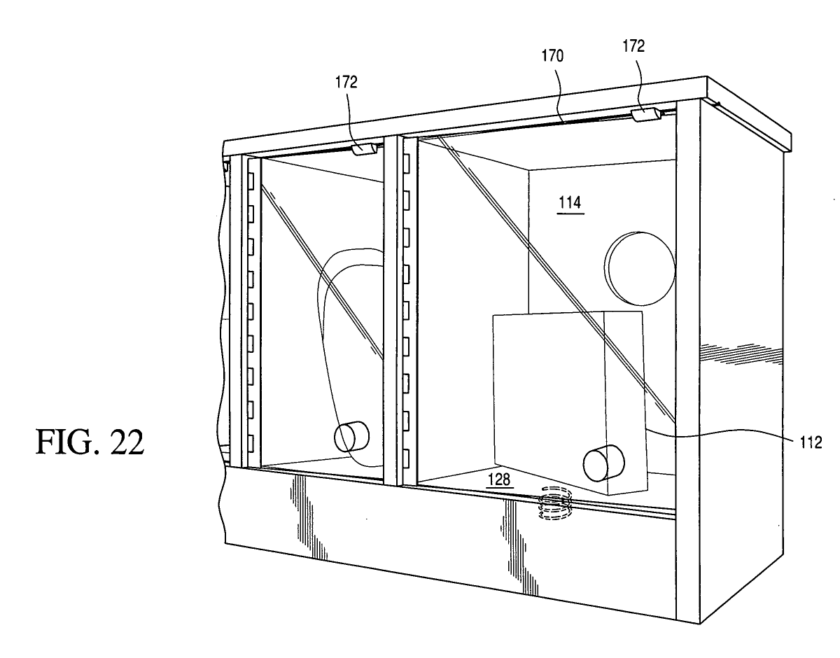

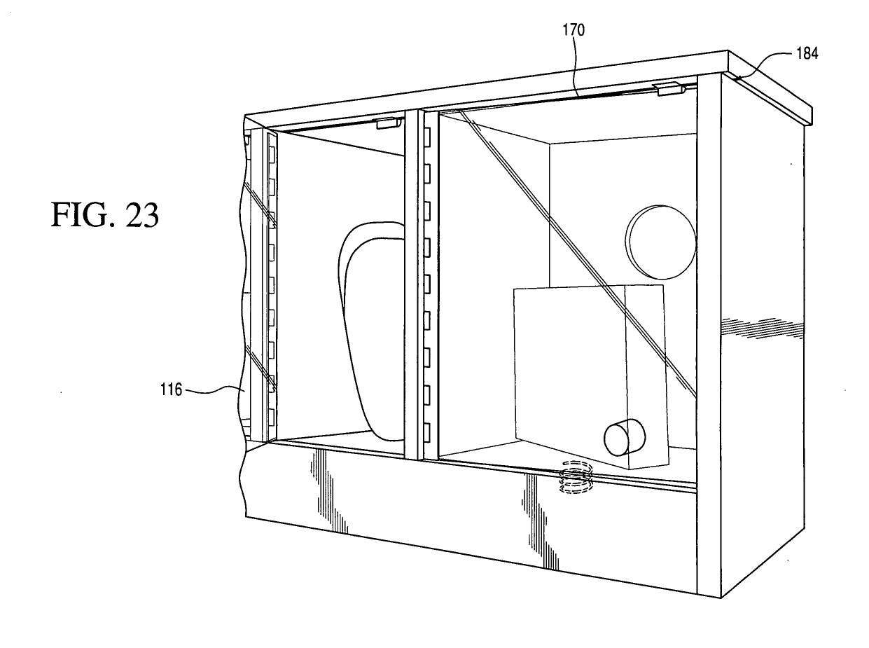

As a result, the only way for the child to access (and remove an object 112 from) another compartment 114 is to return an object 112 to the open compartment 114 (see FIG. 22). Once the object 112 is returned to the compartment 114, the floor 128 of the compartment 114 is lowered under the control of the spring 130. Movement of the floor 128 in this manner allows the door 116 to fully close, which causes rotation of the camshaft 170 and cam lobes 172 to their original orientation (see FIG. 22) where any of the other doors 116 (see FIG. 23) may be opened for retrieval of an object 112.

Similar to the operation of the embodiment described above, operation of the storage and dispensing cabinet 110 begins when the parent or supervisor uses a screwdriver to manipulate the shaft end 184 of the camshaft 170 (see FIG. 23) to allow for successive filling of the compartments 114. Upon filling of the compartments 114, all the doors 116 should be in their fully closed positions and the camshaft 170 and cam lobes 172 in their unlocked positions with the arcuate segments 178 respectively facing the front surfaces 180 of the doors 116.

The child operates the storage and dispensing cabinet 110 by observing the object 112 in the compartments 114 through the transparent door 116 until the child decides which object 112 to select and play with. The child then grasps the knob 154 of the door 116 to the selected compartment 114 and opens the door 116 (see FIG. 18). In the process of opening the door 116 of the compartment 114, the camshaft 170 and cam lobes 172 are rotated to the locked position.

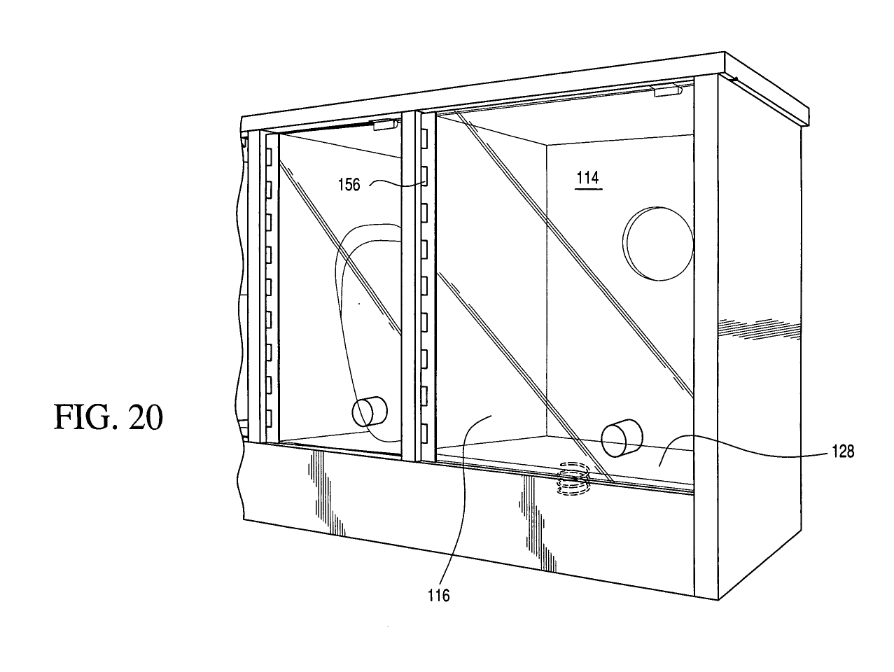

The child then removes the desired object 112 (see FIG. 19), relieving that object's weight from the floor 128, which rises under the influence of the spring 130. The spring loaded hinge 156 will close the door 116 (see FIG. 20), but not to its fully closed position because the raised floor 128 of that now unoccupied compartment 114 will interfere with the full closing of the door 116. The cam lobes 172 of the other compartments 114 will be in the “locked” position and will prevent opening any other door 116 and consequently selection of any other object 112 (see FIG. 21). Once the child tires of the first object 112 and tries to open any other door 116 to select another object 112 the child will be unable to do so. Initially, the parent or supervisor should explain to the child that they must return the first object 112 to the storage and dispensing cabinet 110 and then they can select another object 112. Returning the object 112 to the unoccupied and open compartment 114 will lower the floor 128, thus allowing the door 116 to close and rotating the camshaft 170 to a position that allows access to any other toy. Children will very quickly learn to do this on their own.

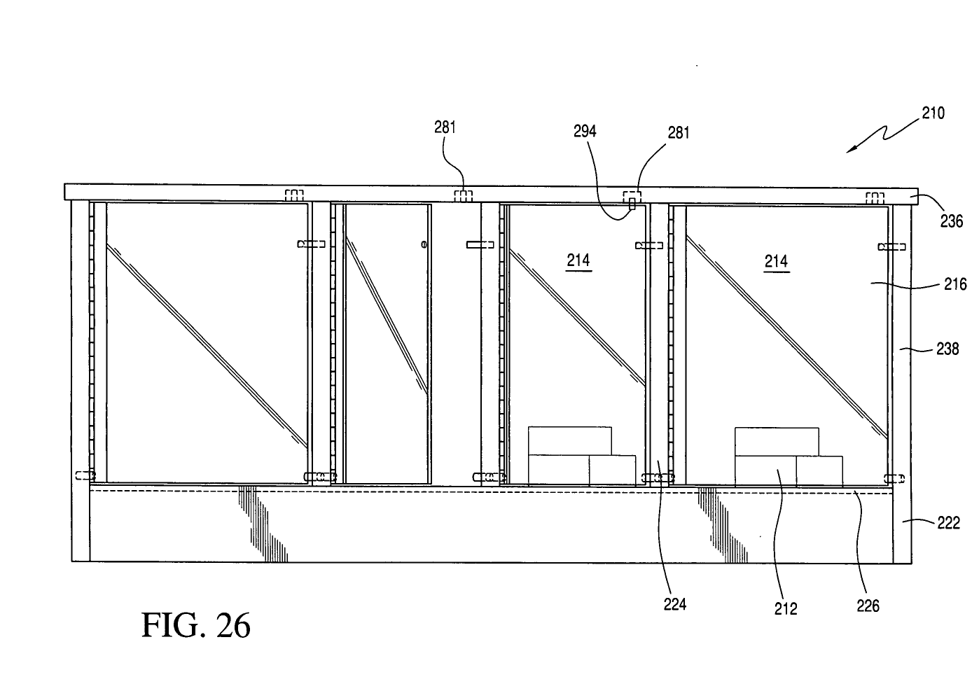

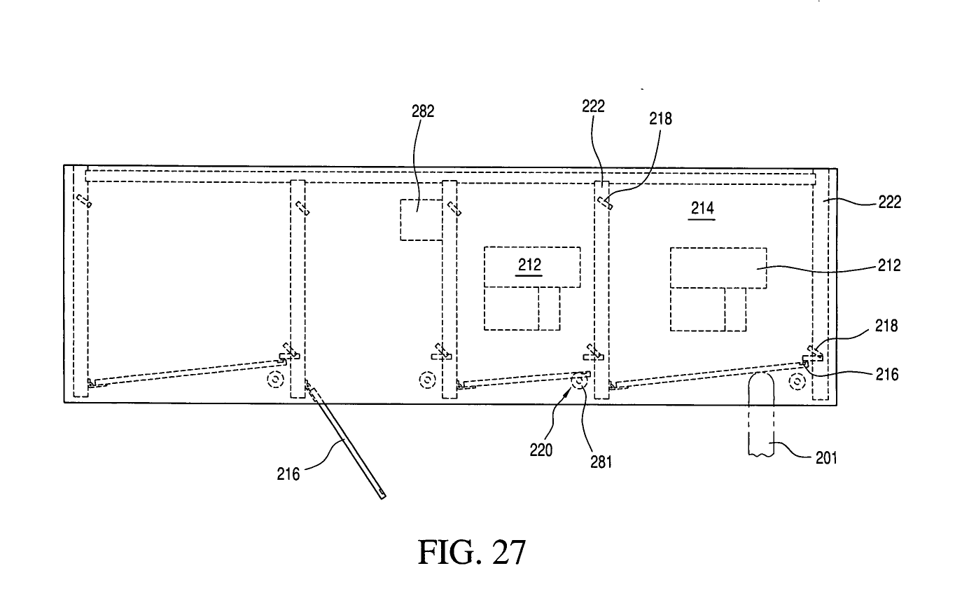

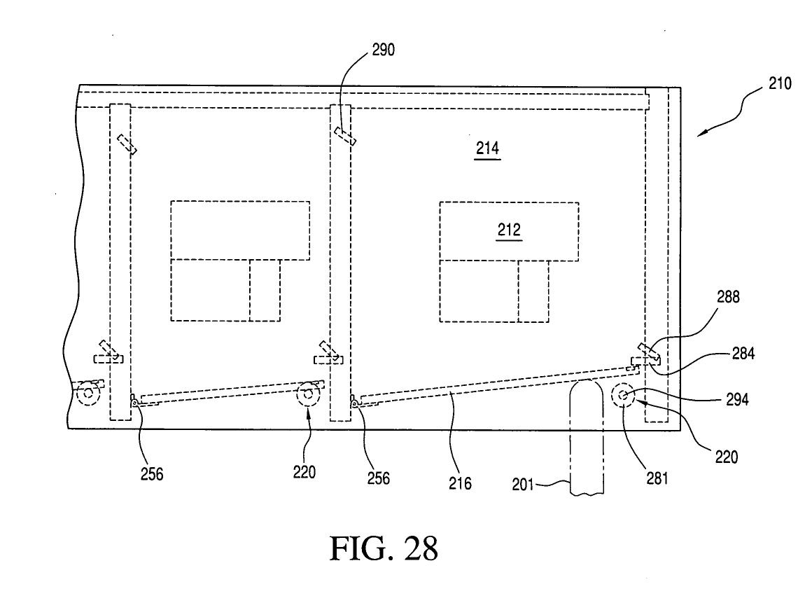

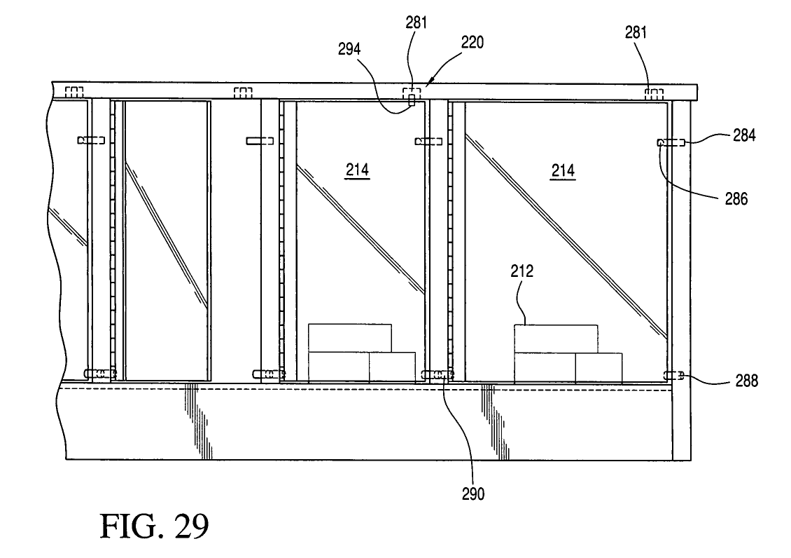

In accordance with yet another embodiment, and with reference to FIGS. 26 to 29, an electronic sensor system is employed in conjunction with the storage and dispensing cabinet 210. In accordance with this embodiment, the storage and dispensing cabinet 210 includes four compartments 214. The compartment 214 are similar to those previously discussed with the exception that the floor does not need to move and the door does not need a handle.

Briefly, the storage and dispensing cabinet 210 includes a plurality of horizontally oriented compartments 214. As with the prior embodiments, opening and closing of the respective compartments 214 is controlled by a lock assembly 220 linked to a sensor 218. In accordance with a preferred embodiment, the lock assembly 220 is composed of a plurality of solenoid lock members 281, each associated with an individual door 216 for controlling locking and unlocking thereof.

The respective compartments 214 are substantially identical and the first compartment 214 will be disclosed herein as those of ordinary skill in the art will understand that each of the compartments 214 includes a substantially similar construction with adjacent compartments 214 sharing adjacent walls. Each compartment 214 includes a base (or floor) 226 and top wall 236 with first and second lateral sidewalls 224, 238 connecting the base 226 to the top wall 236. The door 216 is pivotally secured to the first lateral sidewall 224. As will be appreciated based upon the following disclosure, the sidewalls 224, 238, floor 226 and top wall 236 are configured to enclose the door 216 such that a child cannot get a finger around the edge of the door 216 to try to pry open the door 216.

Each of the compartments 214 includes a spring-loaded hinge 256 rotatably connecting the door 216 to a first lateral sidewall 224 of the compartment 214 allowing one to rotate the door 216 outward for ready access to the objects 212 held therein. However, and in contrast to the embodiments disclosed above, the spring-loaded hinge 256 biases the door 216 outwardly away from the storage compartment 214. While a rotatable door is disclosed in accordance with a preferred embodiment of the present invention, other door structures, for example, sliding doors, are contemplated for use in accordance with the present invention.

As with the prior embodiments, the door 216 is made from a transparent, but durable material. This allows the child to see the contents of the compartment 214. Although a transparent door is disclosed in accordance with a preferred embodiment, it is contemplated other door structures may be utilized without departing from the spirit of the present invention. If an opaque door were to be used, mirrors, labels, photographs, displays, video cameras or other similar structures may be utilized to provide the child with a visual indication as to the contents of the compartment.

In addition, each compartment 214 includes a sensor 218 associated therewith. The storage and dispensing cabinet 210 also includes a lock assembly 220 associated with the respective doors 216 for permitting controlled opening and closing of the doors 216. An electronic logic controller 282 is linked between the sensor 218 and the lock assembly 220 for identifying when a compartment 214 is empty and permitting/preventing access to the compartment 214. For the sake of simplicity the wiring necessary for linking the electronic logic controller 282 to the sensor 218 and the lock assembly 220 is not disclosed in the present drawings although those skilled in the art would certainly understand how to wire the various components making up this embodiment of the present storage and dispensing cabinet 210.

As discussed below in greater detail, the electronic logic controller 282 operates to control selective opening of the doors 216 by considering when proximity switches 284 mounted to the housing 222 of the storage and dispensing cabinet 210 are brought directly adjacent to a magnet 286 secured to the doors 216. The electronic logic controller 282 also only permits opening of a door 216 when the sensors 218 indicate to the electronic logic controller 282 that objects 212 are present within their respective compartments 214. The objects 212 positioned within each compartment 214 are specific objects that can be sensed by the device and the lock assembly 220 allows access only when all the specific objects are in their respective compartments.

In accordance with a preferred embodiment, the sensor 218 is an infrared type sensor. More particularly, the sensor 218 includes an infrared emitter 288 and an infrared sensor 290. By preventing the transmission of a signal from the infrared emitter 288 to the infrared sensor 290, an indication is provided to the electronic logic controller 282 that the compartment 214 is occupied.

In practice, and in order to close the compartment 214, an object 212 is placed within a compartment 214. This prevents the infrared emitter 288 from sending a signal to the infrared sensor 290. By preventing the transmission of a signal from the infrared emitter 288 to the infrared sensor 290, an indication is provided that the compartment is occupied. The solenoid lock member 281 will then lock to permit closing of the door 216 when it is pushed to its closed orientation.

With the object 212 within the compartment 214 and the door 216 closed, the user may use his finger 201 to press the door 216, and specifically the magnet 286 secured to the door 216 adjacent the free end 292 of the door 216, against the proximity switch 284 secured to the housing 222 of the storage and dispensing cabinet 210. Contact of the proximity switch 284 with the magnet 286 informs the electronic logic controller 282 that this compartment 214 should change its state. While direct contract between the magnet and proximity switch is disclosed in accordance with a preferred embodiment of the present invention, it is contemplated activation of the switch may be initiated upon merely placing the magnet in adjacent proximity to the proximity switch or that other electronic switching structures may be employed.

The electronic logic controller 282 sends a signal to solenoid lock member 281 to change from the unlocked position to the locked position. Upon removing the finger 201, the spring loaded hinge 256 presses the door 216 against the solenoid pin 294 of the solenoid lock member 281, thus preventing the door 216 from being opened.

When one desires to open a compartment 214, a finger 201 is used to press the door 216 of a closed and locked compartment 214 against a proximity switch 284. The door 216 is retained in an orientation biasing the door 216 away from the proximity switch 284 due to the spring biased hinge 256 employed in accordance with the present invention and as discussed above. This informs the electronic logic controller 282 to take an action with respect to the compartment 214. The electronic logic controller 282 first verifies that all compartments 214 are occupied with objects by evaluating signals sent to the electronic logic controller 282 by the various sensors 218 associated with the compartments 214. As discussed above, this is achieved by the use of infrared emitters 288 and infrared sensors 290 which identify the presence of an object 212 within a compartment 214 based upon whether the signal issued by the infrared emitter 288 is received by the infrared sensor 290.

If it is determined by the electronic logic controller 282 that all compartments 214 are occupied, then the electronic logic controller 282 sends a signal to the solenoid lock member 281 associated with the door 216 previously pushed into contact with the proximity switch 284 to switch the solenoid lock member 281 to its unlocked position. Upon removing ones hand from the door 216, the spring-loaded hinge 256 will open the door 216 thus allowing access to the object 212.

When the storage and dispensing cabinet 210 is in this state, that is, with an object 212 removed from a compartment 214 and the door 216 biased open, the user will be prevented from removing objects 212 from the other compartment 214. In particular, a user may press any other door 216 against that door's associated proximity switch 284 so as to inform the electronic logic controller 282 that the operator desires to open a door, but since the electronic logic controller 282 will find at least one compartment 214 is empty (based on signals from infrared emitter 288 and infrared sensor 290) the electronic logic controller 282 will take no action and all other solenoid lock members 281 will remain in their locked position. When the object 212 is replaced, and the door 216 is closed, the sensor 218 will instructed the electronic logic controller 282 that the object 212 has been replaced. With this information, the electronic logic controller 282 will now permit the user to access another compartment 214 for retrieval of an object in the same manner as described above.

This electronic embodiment would also have a key switch (not shown) that would allow the parent/supervisor to open all the doors to initially load the device. Those familiar with the art would easily add such a circuit and program.

While the invention has been described with reference to particular embodiments thereof, it is contemplated other arrangements of the cabinet interlocking using mechanical, electromagnetic, magnetic, optical or other sensing and interlocking systems may be employed. In addition sensors to identify a specific object for each compartment would also be within the spirit of this invention.

While the invention has been described with reference to particular embodiments thereof, it is contemplated other arrangements of the cabinet interlocking using mechanical, electromagnetic, magnetic, optical or other sensing and interlocking systems may be employed.

While the preferred embodiments have been shown and described, it will be understood that there is no intent to limit the invention by such disclosure, but rather, is intended to cover all modifications and alternate constructions falling within the spirit and scope of the invention.

1. A storage and dispensing cabinet, comprising:
a housing having a plurality of compartments, each compartment including a door controlling access thereto;
each of the compartments includes a sensor for identifying whether an object is positioned within the compartment;
a lock assembly associated with the doors of the plurality of compartments for controlling access to the compartments for removal of objects stored therein;
wherein the lock assembly permits access to one of the selected compartments for removal of the object stored therein only when an object is identified as being positioned within each of the compartments of the cabinet.

2. The storage and dispensing cabinet according to claim 1, wherein the lock assembly permits access to one of the selected compartments for removal of the object stored therein only when all of the doors of the compartments are closed.

3. The storage and dispensing cabinet according to claim 1, the sensor is a weight sensor.

4. The storage and dispensing cabinet according to claim 1, wherein the sensor is a spring secured to a movable floor of the compartment.

5. The storage and dispensing cabinet according to claim 4, wherein the spring is biased such that when an object is positioned upon the floor, the spring moves downwardly under the weight of the object thereby providing the floor with an unoccupied orientation and an occupied orientation.

6. The storage and dispensing cabinet according to claim 5, wherein the door is prevented from closing when the floor is in the unoccupied orientation.

7. The storage and dispensing cabinet according to claim 1, wherein the lock assembly is a rotatable disc missing an arcuate segment.

8. The storage and dispensing cabinet according to claim 7, wherein the rotatable disc interacts with knobs secured to the respective doors allowing or preventing the rotatable disc from freely rotating.

9. The storage and dispensing cabinet according to claim 1, wherein the objects positioned within each compartment are specific objects that can be sensed and the lock assembly allows access only when all the specific objects are in their respective compartments.

10. The storage and dispensing cabinet according to claim 7, further including a magnetic screw mounted on the rotatable disc and magnets mounted at selected positions on the housing of the cabinet wherein the magnetic screw and magnets interact when the rotatable disc is rotated.

11. The storage and dispensing cabinet according to claim 1, wherein the lock assembly is composed of a camshaft upon which is mounted a plurality of cam lobes.

12. The storage and dispensing cabinet according to claim 11, wherein a cam lobe is associated with each of the respective compartments.

13. The storage and dispensing cabinet according to claim 12, wherein each of the cam lobes is a substantially cylindrical member with a missing an arcuate segment.

14. The storage and dispensing cabinet according to claim 1, wherein the sensor is an infrared type sensor.

15. The storage and dispensing cabinet according to claim 14, wherein the infrared type sensor includes a sensor emitter and infrared sensor.

16. The storage and dispensing cabinet according to claim 1, wherein the lock assembly includes a plurality of solenoid lock members associated with the plurality of storage compartments.

17. The storage and dispensing cabinet according claim 1, further including an electronic logic controller controlling the lock assembly.

18. The storage and dispensing cabinet according to claim 17, wherein the lock assembly includes a plurality of solenoid lock members associated with the plurality of storage compartments.

19. The storage and dispensing cabinet according to claim 18, wherein the sensor is linked to the electronic logic controller.

20. The storage and dispensing cabinet according to claim 19, wherein the sensor includes an infrared emitter and an infrared sensor.
